(19) United States
(12) Patent Application Publication
(10) Pub. No.: US 2007/0073009 A1
(43) Pub. Date: Mar. 29, 2007

(54) Hardeners for coating compositions (II)

(76) Inventors: Giorgio Sabbadini, Rho (IT); Thorsten Roloff, Monchengladbach (DE); Paul Birnbrich, Solingen (DE); Hans-Josef Thomas, Korschenbroich (DE)

Correspondence Address: COGNIS CORPORATION;PATENT DEPARTMENT, 300 BROOKSIDE AVENUE, AMBLER, PA, 19002, US

(21) Appl. No.: 11/451,938

(22) Filed: Jun. 13, 2006

(30) Foreign Application Priority Data
Jun. 23, 2005 (DE) 10 2005 029 144.9

(51) Int. Cl. C08G 59/14

(52) U.S. Cl. 525/524; 525/534

(57) ABSTRACT

The invention relates to hardeners for water-based epoxy resin systems providing a longer resin pot life, incorporating particular carbonyl compounds (F) and being obtainable by (i) reacting a mixture of (A) at least one epoxidized polyalkylene oxide (A), (B) at least one epoxidized aromatic hydroxy compound (B); (C) at least one aromatic hydroxy compound (C); and (D) optionally, at least one di- or tri-glycidyl ether compound (D), to form a first intermediate product (Z1) having an epoxy value of less than 10%; (ii) reacting the intermediate product (Z1) with a polyamine (E) to form a second intermediate product (Z2); and
(iii) reacting the intermediate product (Z2) with a carbonyl compound (F) having the general formula (I):

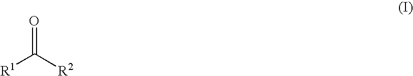

wherein R¹ and R² independently represent hydrogen, a C₁₋₂₂ alkyl group or a C₆H₅, OH, OR³ group, where R³ is a C₁₋₂₂ alkyl group; among others. The resin mixtures provide clear floor coatings.

### CROSS REFERENCE TO RELATED APPLICATIONS

This application claims priority under 35 USC §119 from German Patent Application No.10 2005 029 144.9, filed Jun. 23, 2005.

### STATEMENT REGARDING FEDERALLY SPONSORED RESEARCH OR DEVELOPMENT

Not applicable.

### BACKGROUND OF THE INVENTION

1. Technical Field

This invention relates to coating compositions with long pot lives and relatively little tendency towards shrinkage. These coating compositions are obtainable by reaction of epoxy resins and special hardeners according to the invention, these hardeners being obtainable by reacting a mixture of epoxidized polyalkylene oxide, an epoxidized aromatic hydroxy compound and an aromatic hydroxy compound to form a first intermediate product, subsequently reacting this intermediate product with a polyamine to form a second intermediate product and, finally, reacting the second intermediate product with carbonyl-containing compounds having a special structure.

2. Background Art

U.S. Pat. No. 4,608,405 describes hardeners for epoxy resins. These hardeners are produced as follows: a first intermediate compound, a diepoxy compound (a) obtainable by reaction of diglycidyl ethers of dibasic phenols, diglycidyl ethers of aliphatic dihydroxy polyethers and dibasic phenols with a polyamine (b) containing primary amino groups are reacted to form a second intermediate compound, with the proviso that practically all the epoxy groups present in (a) are substantially quantitatively reacted with the polyamine (b). The second intermediate compound obtained is then reacted with a compound (c) from the group of monoepoxides or monocarboxylic acids, with the proviso that at least all the primary amino groups of the polyamines (b) are reacted with the compounds (c), resulting in the formation of a third intermediate compound which, finally, is converted into an ionic compound by addition of a volatile acid, such as formic, acetic or propionic acid. According to the disclosure of U.S. Pat. No. 4,608,405, this ionic compound is a hardener for water-based epoxy resin systems.

WO 93/21250 describes a process for the production of aqueous emulsions of epoxy resin hardeners containing free amino groups. These epoxy resin hardeners in turn are adducts of epoxy resins and aminofunctional compounds.

EP-A-253,405 describes compositions containing cationic epoxy resins. These compositions are produced by reaction of a component (a) containing a diglycidyl ether of a polyol and a diglycidyl ether of a dibasic phenol with a dibasic phenol (b) and optionally a capping agent (c), resulting in the formation of an epoxy resin containing terminal oxirane rings. These terminal oxirane rings are then converted into cationic groups by reaction with nucleophiles and addition of an organic acid and water during the process.

EP-A-1,518,875 describes hardeners for water-based epoxy resin systems which are obtained by reaction of a mixture of (a) at least one epoxidized polyalkylene oxide selected from the group of epoxidized polyethylene oxides, epoxidized polypropylene oxides and polyethylene propylene oxides, (b) at least one epoxidized aromatic hydroxy compound selected from the group of bisphenol A epoxides and bisphenol F epoxides and (c) at least one aromatic hydroxy compound selected from the group consisting of bisphenol A and bisphenol F to form an intermediate product and subsequent reaction of this intermediate product with a polyamine (E).

### BRIEF SUMMARY OF THE INVENTION

The problem addressed by the present invention was to provide hardeners for water-based epoxy resin systems which, when used in the reaction with epoxy resins, would lead to the formation of coating compositions or coatings distinguished by a comparatively long pot life. The end of the pot life would be reflected in a distinct increase in the viscosity of the mixture. In addition, the hardeners would be self-emulsifying in water and would be capable of emulsifying added liquid epoxy resins in water or water-containing systems.

Another problem addressed by the invention was to provide hardeners for water-based epoxy resin systems which, when used in the reaction with epoxy resins, would lead to the formation of coating compositions or coatings distinguished by a particularly low tendency to shrink. Another problem addressed by the invention was to provide hardeners for water-based epoxy resin systems which would develop distinct hardness after a short drying time.

It has now surprisingly been found that coating compositions obtainable by reaction of epoxy resins and special hardeners—these hardeners being obtainable by reacting a mixture of epoxidized polyalkylene oxides, epoxidized aromatic hydroxy compounds and aromatic hydroxy compounds to form a first intermediate product, subsequently reacting this intermediate product with polyamine to form a second intermediate product and finally reacting the second intermediate product with carbonyl-containing compounds—satisfy these requirements excellently in every respect.

In a first embodiment, the present invention relates to hardeners for water-based epoxy resin systems, these hardeners being obtainable by reacting a mixture of
(A) at least one epoxidized polyalkylene oxide selected from the group of epoxidized polyethylene oxides, epoxidized polypropylene oxides and polyethylene propylene oxides,
(B) at least one epoxidized aromatic hydroxy compound selected from the group of bisphenol A epoxides and bisphenol F epoxides and
(C) at least one aromatic hydroxy compound selected from the group of bisphenol A and bisphenol F
   to form a first intermediate product (Z1), subsequently reacting this intermediate product (Z1) with a polyamine (E) to form a second intermediate product (Z2) and, finally, reacting the intermediate product (Z2) with at least one compound (F),
   with the proviso that the compounds (F) are selected from the group of carbonyl-containing compounds corresponding to general formula (I): 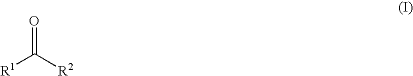
   in which the substituents R¹ and R² independently of one another represent hydrogen, a saturated, linear or branched C₁₋₂₂ alkyl group or a C₆H₅, OH, OR³ group, where R³ is a saturated or unsaturated, linear or branched C₁₋₂₂ alkyl group, and with the further proviso that at least 1% and at most 99% of the primary amino groups present in the intermediate product (Z2) is/are allowed to react off. Further alternative carbonyl compounds (F) are described below.

With the quite outstanding properties of the hardeners according to the invention in mind, it is pointed out in particular that the pot lives of clear lacquers obtainable using the hardeners according to the invention are excellent. With clear lacquer formulations based on the hardeners of Table 1 of the Examples of the present application, the clear lacquer can still readily be applied after 60 minutes, a clear, colorless transparent lacquer being obtained. The end of the pot life is characterized by a distinct increase in the viscosity of the mixture and is clearly reflected in the fact that the viscosity increases by more than three-fold relative to the initial viscosity.

The present invention also relates to the use of the hardeners according to the invention for the production of clear lacquers, coating compositions and the like.

### DETAILED DESCRIPTION OF THE INVENTION

As noted above, the present invention provides hardeners for water-based epoxy resin systems providing a longer resin pot life, the hardeners being obtainable by
(i) reacting a mixture of
(A) at least one epoxidized polyalkylene oxide (A) selected from the group of epoxidized polyethylene oxides, epoxidized polypropylene oxides and polyethylene propylene oxides,
(B) at least one epoxidized aromatic hydroxy compound (B) selected from the group of bisphenol A epoxides and bisphenol F epoxides;
(C) at least one aromatic hydroxy compound (C) selected from the group of bisphenol A and bisphenol F; and
(D) optionally, at least one di- or tri-glycidyl ether compound (D) selected from the group of triglycidyl ethers of triols and a diglycidyl ether of diols,
to form a first intermediate product (Z1) having an epoxy value of less than 10%;
(ii) subsequently reacting the intermediate product (Z1) with a polyamine
(E) to form a second intermediate product (Z2); and
(iii) reacting the intermediate product (Z2) with at least one carbonyl compound (F) selected from the group of carbonyl-containing compounds corresponding to general formula (I): 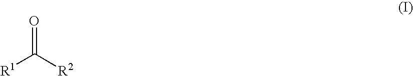
   in which:
   (a) the substituents R¹ and R² independently represent hydrogen, a saturated, linear or branched C₁₋₂₂ alkyl group or a C₆H₅, OH, OR³ group, where R³ is a saturated or unsaturated, linear or branched C₁₋₂₂ alkyl group, or
   (b) R¹ and R² each represent a saturated C₁₋₂₂ alkyl group linked to one another and to the carbonyl carbon atom to form a ring, or
   (c) R¹ and R² each represent a saturated C₁₋₂₂ alkyl group linked to one another and to the carbonyl carbon atom together with an —O— atom adjacent to the carbonyl carbon to form a lactone ring, or
   (d) one of R¹ and R² represents a saturated C₁₋₂₂ alkyl group with an amino or OH group as substituent in the alpha position to the carbonyl carbon atom and the other represents OH or an OR³ group, where R³ is a saturated or unsaturated, linear or branched C₁₋₂₂ alkyl group, or
   (e) R¹ and R² together represent oxygen,
      with the proviso that at least 1% and at most 99% of the primary amino groups present in the intermediate product (Z2) are allowed to react off.

The present invention further provides the foregoing process for producing the hardeners having the special carbonyl compounds (F).

The present invention further provides a process for the production of a clear lacquer or a coating composition, comprising reacting, in an aqueous medium,
(1) a polyepoxide compound (G), containing an average of at least two terminal or lateral epoxy groups per molecule, with
(2) a hardener obtained by
(i) reacting a mixture of
(A) at least one epoxidized polyalkylene oxide (A) selected from the group of epoxidized polyethylene oxides, epoxidized polypropylene oxides and polyethylene propylene oxides;
(B) at least one epoxidized aromatic hydroxy compound (B) selected from the group of bisphenol A epoxides and bisphenol F epoxides;
(C) at least one aromatic hydroxy compound (C) selected from the group of bisphenol A and bisphenol F; and
(D) optionally, at least one di- or tri-glycidyl ether compound (D) selected from the group of triglycidyl ethers of triols and diglycidyl ethers of diols,
   to form a first intermediate product (Z1) having an epoxy value of less than 10%,
(ii) subsequently reacting this intermediate product (Z1) with a polyamine
(E) to form a second intermediate product (Z); and
(iii) reacting the intermediate product (Z2) with at least one carbonyl compound (F) selected from the group of carbonyl-containing compounds corresponding to general formula (I): 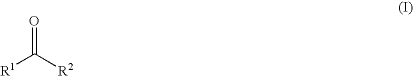
   in which:
   (a) the substituents R¹ and R² independently represent hydrogen, a saturated, linear or branched C₁₋₂₂ alkyl group or a C₆H₅, OH, OR³ group, where R³ is a saturated or unsaturated, linear or branched C₁₋₂₂ alkyl group, or
   (b) R¹ and R² each represent a saturated C₁₋₂₂ alkyl group linked to one another and to the carbonyl carbon atom to form a ring, or
   (c) R¹ and R² each represent a saturated C₁₋₂₂ alkyl group linked to one another and to the carbonyl carbon atom together with an —O— atom adjacent to the carbonyl carbon to form a lactone ring, or
   (d) one of R¹ and R² represents a saturated C₁₋₂₂ alkyl group with an amino or OH group as substituent in the alpha position to the carbonyl carbon atom and the other represents OH or an OR³ group, where R³ is a saturated or unsaturated, linear or branched C₁₋₂₂ alkyl group, or
   (e) R¹ and R² together represent oxygen,
      with the proviso that at least 1% and at most 99% of the primary amino groups present in the intermediate product (Z2) are allowed to react off.

The components (A)-(F) and processes for making (Z1), (Z2) and the resins having the longer pot lives are further described below.

Compounds (A)

In the context of the present invention, epoxidized polyethylene oxides are understood to be compounds which can be obtained by converting the two terminal OH groups of polyethylene oxide into oxirane groups, for example by reaction with epichlorohydrin. The polyethylene oxide used may have an average molecular weight of 80 to 3,000 and may be produced by starting the polymerization of the ethylene oxide with a C₂₋₁₈ alkylene diol, as known to the expert.

In the context of the invention, epoxidized polypropylene oxides are understood to be compounds which can be obtained by converting the two terminal OH groups of polypropylene oxide into oxirane groups, for example by reaction with epichlorohydrin. The polypropylene oxide used may have an average molecular weight of 110 to 3,000 and may be produced by starting the polymerization of the propylene oxide with a C₂₋₁₈ alkylene diol, as known to the expert.

In the context of the invention, polyethylene propylene oxides are understood to be compounds which can be obtained by converting the two terminal OH groups of polyethylene propylene oxide into oxirane groups, for example by reaction with epichlorohydrin. The polyethylene propylene oxide used may have an average molecular weight of 80 to 3,000. Polyethylene propylene oxides are compounds obtainable by copolymerization of ethylene and propylene oxide, the polymerization of the two reactants being carried out simultaneously or blockwise by starting the polymerization of the propylene oxide and/or the ethylene oxide with a C₂₋₁₈ alkylene diol, as known to the expert.

The compounds (A) may be used individually or in the form of mixtures with one another.

Compounds (B)

In the context of the invention, bisphenol A epoxides are as always understood to be compounds obtainable by reacting bisphenol A with epichlorohydrin and/or polymerizing it by further reaction with bisphenol A. Accordingly, these compounds are also known as bisphenol A diglycidyl ethers or, generally, as epoxy resins. Commercially available products are Epikote 828, 1001, 1002, 1003, 1004 (Shell).

The molecular weights of the bisphenol A epoxides used are preferably in the range from 300 to 3,000.

In the context of the invention, bisphenol F epoxides are as always understood to be compounds obtainable by reacting bisphenol F with epichlorohydrin and/or polymerizing it by further reaction with bisphenol F. Accordingly, these compounds are also known as bisphenol F diglycidyl ethers or, generally, as bisphenol F epoxy resins.

The molecular weights of the bisphenol F epoxides used are preferably in the range from 270 to 3,000.

The compounds (B) may be used individually or in the form of mixtures with one another.

Compounds (C)

Bisphenol A is known to the expert and is characterized by the following formula:

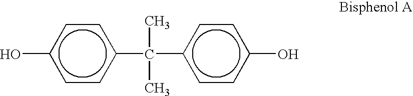

Bisphenol F is also known to the expert.

The compounds (C) may be used individually or in the form of mixtures with one another.

Compounds (D)

In one embodiment, the compounds (D) are used in addition to the compounds (A), (B) and (C) for the production of the intermediate product (Z1) which is subsequently reacted with the polyamines (E) to form the intermediate product (Z2). The compounds (D) are compounds from the group of triglycidyl ethers of triols and diglycidyl ethers of diols. The following are mentioned as examples of suitable diols and triols on which the compounds (D) are based: ethylene glycol, diethylene glycol, triethylene glycol, 1,2-propylene glycol, 1,3-propylene glycol, 1,4-butylene glycol, pentane-1,5-diol, hexane-1,6-diol, cyclohexane diol, cyclohexane dimethanol, neopentyl glycol, hexane-1,2,6-triol, glycerol and trimethylol propane.

The compounds (D) may be used individually or in the form of mixtures with one another.

In the interests of clarity, it is pointed out that, accordingly, the present invention also relates to hardeners for water-based epoxy resin systems, these hardeners being obtainable by reacting a mixture of
(A) at least one epoxidized polyalkylene oxide selected from the group of epoxidized polyethylene oxides, epoxidized polypropylene oxides and polyethylene propylene oxides,
(B) at least one epoxidized aromatic hydroxy compound selected from the group of bisphenol A epoxides and bisphenol F epoxides,
(C) at least one aromatic hydroxy compound selected from the group of bisphenol A and bisphenol F and
(D) at least one compound selected from the group of triglycidyl ethers of triols and diglycidyl ethers of diols
   to form a first intermediate product (Z1), subsequently reacting this intermediate product (Z1) with a polyamine (E) to form a second intermediate product (Z2) and, finally, reacting the intermediate product (Z2) with at least one compound (F), with the proviso that the compounds (F) are selected from the group of carbonyl-containing compounds and with the further proviso that at least 1% and at most 99% of the primary amino groups present in the intermediate product (Z2) is/are allowed to react off.
   Compounds (E)

The polyamines (E) used in accordance with the present invention are amines containing at least two primary amino groups per molecule. Additional other amino groups may optionally be present. Aliphatic, aromatic, aliphatic-aromatic, cycloaliphatic and heterocyclic di- and polyamines may be used as the compounds (E).

The following are examples of suitable polyamines (E): polyethylene amines(ethylene diamine, diethylene triamine, triethylene tetramine, tetraethylene pentamine, etc.), 1,2-propylene diamine, 1,3-propylene diamine, 1,4-butane diamine, 1,5-pentane diamine, 1,3-pentane diamine, 1,6-hexane diamine, 3,3,5-trimethyl-1,6-hexanediamine, 3,5,5-trimethyl-1,6-hexane diamine, 2-methyl-1,5-pentane diamine, bis-(3-aminopropyl)-amine, N,N′-bis-(3-aminopropyl)-1,2-ethane diamine, N-(3-aminopropyl)-1,2-ethane diamine, 1,2-diaminocyclohexane, 1,3-diaminocyclohexane, 1,4-diaminocyclohexane, the poly(alkyleneoxide)diamines and triamines (such as, for example, Jeffamine D-230, Jeffamine D400, Jeffamine D-2000, Jeffamine D4000, Jeffamine T403, Jeffamine EDR-148, Jeffamine EDR-192, Jeffamine C-346, Jeffamine ED-600, Jeffamine ED-900, Jeffamine ED-2001), meta-xylyene diamine, phenylene diamine, 4,4′-diaminodiphenyl methane, toluene diamine, isophorone diamine, 3,3′-dimethyl-4,4′-diaminodicyclohexyl methane, 4,4′-diaminodicyclohexyl-methane, 2,4′-diaminodicyclohexyl methane, 1,3-bis-(aminomethyly cyclohexane, the mixture of poly(cyclohexylaromatic)amines attached by a methylene bridge (also known as MBPCAA) and polyaminoamides. Polyethylene amines, especially diethylene triamine, are particularly preferred.

The compounds (E) may be used individually or in admixture with one another.

In one embodiment, the compounds (E) may be used in combination with amines (E*), with the proviso that the amines (E*) are amines that do not come under the definition of the amines (E). Examples of such amines (E*) are amines with only one primary amino group per molecule, such as cyclohexylamine, methylamine, ethylamine, propylamine, butylamine, pentylamine, hexylamine, heptylamine, octylamine, nonylamine, decylamine, undecylamine, dodecylamine, tridecylamine, tetradecylamine, pentadecylamine, hexadecylamine, heptadecylamine, octadecylamine, aniline, Jeffamine M 2070, Jeffamine M 600, ethanolamine.

If mixtures of (E) and (E*) are used, the percentage of (E) in such mixtures is at least 10% by weight, preferably at least 40% by weight and, more particularly, at least 60% by weight.

In one preferred embodiment, one or more compounds (E), but no compounds (E*), are used.

Compounds (F)

According to the invention, the carbonyl-containing compounds (F) are selected from compounds corresponding to general formula (I): 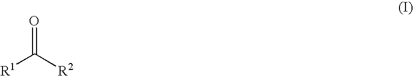
in which the substituents R¹ and R² independently of one another represent hydrogen, a saturated, linear or branched C₁₋₂₂ alkyl group or a C₆H₅, OH, OR³ group, where R³ is a saturated or unsaturated, linear or branched C₁₋₂₂ alkyl group.

In one embodiment, the compounds of formula (I) are subject to the additional proviso that, where they each represent a saturated C₁₋₂₂ alkyl group, the substituents R¹ and R² may be attached (i.e. linked) to one another, so that they form a ring together with the carbonyl carbon atoms. In this case, one of the CH₂ groups in the alpha position to the carbonyl group is replaced by a substituent —O— which, chemically, means that compound (I) is a lactone, for example gamma-butyrolactone or epsilon-caprolactone.

In another embodiment, the compounds of formula (I) are subject to the additional proviso that, where they each represent a saturated C₁₋₂₂ alkyl group, the substituents R¹ and R² may carry an amino or OH group as substituent in the alpha position to the carbonyl carbon atoms. Examples of such compounds (I) are alpha-hydroxycarboxylic acids or alpha-aminocarboxylic acids.

In another embodiment, the compounds of formula (I) are subject to the additional proviso that the substituents R¹ and R² together may represent oxygen. In this case, the compound (I) is carbon dioxide.

Examples of suitable compounds (F) are carboxylic acids and anhydrides thereof, carboxylic acid esters, acetone, formaldehyde, ketones, carbonates such as, for example, ethylene carbonate, propylene carbonate, carbon dioxide.

Preferred hardeners according to invention include those wherein the carbonyl compound (F) is selected from the group consisting of carboxylic acids and anhydrides, carboxylic acid esters, lactones, acetone, formaldehyde, ketones, alpha-hydroxycarboxylic acids, alpha-aminocarboxylic acids, carbonates and carbon dioxide.

More preferred hardeners according to the invention include those wherein the carbonyl compound (F) is selected from the group consisting of gamma-butyrolactone, epsilon-caprolactone, ethylene carbonate, propylene carbonate, and carbon dioxide.

Production of the Intermediate Product (Z1)

In one embodiment, compounds (A) and (B) are used in a molar ratio of 0.1:1 to 5:1 in the production of the intermediate product (Z1).

In another embodiment, a molar ratio of the sum of compounds (A) and (B) (these compounds each contain two oxirane groups per molecule) to compound (C) (this compound contains two OH groups per molecule) of 1.1:1 to 10:1 is adjusted in the production of the intermediate product (Z1). In other words, the equivalent ratio of oxirane rings in the sum of compounds (A) and (B) to reactive hydrogen atoms in compound (C) is adjusted to a value of 1.1:1 to 10:1.

In another embodiment, namely in cases where at least one compound (D) is also used in the production of the intermediate product (Z2), a molar ratio of the sum of compounds (A), (B) and (D) (these compounds each contain two oxirane groups per molecule) to compound (C) (this compound contains two OH groups per molecule) of 1.1:1.0 to 10.0:1.0 is adjusted in the production of the intermediate product (Z1). In other words, the equivalent ratio of oxirane rings in the sum of compounds (A), (B) and (D) to reactive hydrogen atoms in compound (C) is adjusted to a value of 1.1:1.0 to 10.0:1.0.

In the interests of clarity, the following explanation is offered: The expression “equivalent ratio” is familiar to the expert. The basic concept behind the notion of the equivalent is that, for every substance participating in a reaction, the reactive groups involved in the desired reaction are taken into consideration. By indicating an equivalent ratio, it is possible to express the ratio which all the various reactive groups of the compounds (x) and (y) used bear to one another. It is important in this connection to bear in mind that a reactive group is understood to be the smallest possible reactive group, i.e. the notion of the reactive group is not identical with the notion of the functional group. In the case of H-acid compounds, this means for example that, although OH groups or NH groups represent such reactive groups, NH₂ groups with two reactive H atoms positioned at the same nitrogen atom do not. In their case, the two hydrogen atoms within the functional group NH₂ are appropriately regarded as reactive groups so that the functional group NH₂ contains two reactive groups, namely the hydrogen atoms.

In one embodiment, the production of the intermediate product (Z1) is carried out in the presence of a catalyst, more particularly triphenyl phosphine or ethyl triphenyl phosphonium iodide. The catalyst is used in a quantity of about 0.01 to 1.0% by weight, based on the total quantity of compounds (A), (B) and (C). The epoxy value (% EpO) of the intermediate product is preferably below 10% EpO and more particularly below <5% EpO. The definition of epoxy value and information on its analytical determination can be found in the Examples of the present application.

Production of the Intermediate Product (Z2)

As already mentioned, the intermediate product (Z2) is produced by reacting the intermediate product (Z1) with a polyamine (E).

In one embodiment, the intermediate product (Z1) and the polyamine (E) are used in such quantities that the equivalent ratio of the reactive H atoms at the amino nitrogen atoms of (E) to the oxirane groups in the intermediate compound (Z1) is in the range from 4:1 to 100:1 and, at the same time, the ratio of oxirane groups to primary amines is at least 1:1.01.

The reaction of the intermediate product (Z1) with the polyamine is preferably carried out by initially introducing the polyamine in excess so as to ensure that essentially 1 molecule of the polyamine, preferably diethylene triamine, reacts with one of the epoxy groups of the intermediate compound (Z1). Excess amine can be distilled off to keep the free amine content as low as possible.

Production of the Hardener According to the Invention

To produce the hardener according to the invention, the intermediate product (Z2) is reacted with at least one compound (F), with the proviso that at least 1% and at most 99% of the primary amine groups present in the intermediate product (Z2) is/are allowed to react off.

In a preferred embodiment, at least 25% and at most 75% of the primary amino groups present in the intermediate product (Z2) is/are allowed to react off.

In a particularly preferred embodiment, at least 40% and at most 60% of the primary amino groups present in the intermediate product (Z2) is/are allowed to react off.

Production of Coating Compositions

The present invention also relates to a process for the production of clear lacquers, coating compositions and the like which are obtainable by combining and reacting the above-mentioned hardeners according to the invention with epoxy compounds (G) while stirring in an aqueous medium.

The epoxy compounds (G) are polyepoxides containing on average at least two terminal or lateral epoxy groups per molecule. These epoxy compounds may be both saturated and unsaturated and aliphatic, cycloaliphatic, aromatic and heterocyclic and may also contain hydroxyl groups. They may also contain substituents which do not cause any troublesome secondary reactions under the mixing and reaction conditions, for example alkyl or aryl substituents, ether groups and the like. These epoxy compounds are preferably polyglycidyl ethers based on polyhydric, preferably dihydric, alcohols, phenols, hydrogenation products of these phenols and/or novolaks (reaction products of mono- or polyhydric phenols with aldehydes, more particularly formaldehyde, in the presence of acidic catalysts). The epoxy equivalent weights of these epoxy compounds are preferably between 160 and 3,200 and more preferably between 170 and 830. The epoxy equivalent weight of a substance is the quantity of the substance (in grams) which contains 1 mol of oxirane rings.

Preferred polyhydric phenols are the following compounds: resorcinol, hydroquinone, 2,2-bis-(4-hydroxyphenyl)-propane (bisphenol A), isomer mixtures of dihydroxydiphenyl methane (bisphenol F), tetrabromobisphenol A, 4,4′-dihydroxydiphenyl cyclohexane, 4,4′-dihydroxy-3,3-dimethyldiphenyl propane, 4,4′-dihydroxydiphenyl, 4,4′-dihydroxybenzophenol, bis-(4-hydroxyphenyl)-1,1-ethane, bis-(4-hydroxyphenyl)-1,1-isobutane, bis-(4-hydroxyphenyl)-methane, bis-(4-hydroxyphenyl)-ether, bis-(4-hydroxyphenyl)-sulfone etc. and the chlorination and bromination products of the above-mentioned compounds. Bisphenol A is most particularly preferred.

The polyglycidyl ethers of polyhydric alcohols are also suitable compounds (G). Examples of such polyhydric alcohols are ethylene glycol, diethylene glycol, triethylene glycol, 1,2-propylene glycol, polyoxypropylene glycols (n=1−20), 1,3-propylene glycol, 1,4-butylene glycol, pentane-1,5-diol, hexane-1,6-diol, hexane-1,2,6-triol, glycerol and bis-(4-hydroxy-cyclohexyl)-2,2-propane.

Other suitable compounds (G) are polyglycidyl ethers of polycarboxylic acids obtained by reaction of epichlorohydrin or similar epoxy compounds with an aliphatic, cycloaliphatic or aromatic polycarboxylic acid, such as oxalic acid, succinic acid, adipic acid, glutaric acid, phthalic acid, terephthalic acid, hexahydrophthalic acid, 2,6-naphthalenedicarboxylic acid and dimerized linolenic acid. Examples are adipic acid diglycidyl ester, phthalic acid diglycidyl ester and hexahydrophthalic acid diglycidyl ester.

Mixtures of several epoxy compounds (G) may also be used.

In addition, additives and/or processing aids known to the relevant expert may be used in the production of coating compositions where, as mentioned above, the hardeners according to the invention are reacted with epoxy compounds (G) in aqueous medium. Examples include pigments, cement, gravel, deaerators, defoamers, dispersion aids, antisedimenting agents, accelerators, free amines, flow control additives, conductivity improvers.

So far as the layer thickness of the coating compositions is concerned, the hardeners according to the invention may be used in coating compositions for layer thicknesses of 0.01 to 10 mm and preferably for layer thicknesses of 0.05 to 3 mm.

In addition, the very slight tendency towards shrinkage of the cured compositions achieved by the use of the hardeners to be used in accordance with the invention can be further reduced by adjusting a high pigment content.

The present invention also relates to the cured compositions obtainable by reacting the above-mentioned hardeners according to the invention with epoxy compounds (G) in aqueous medium and then curing the resulting product.

In one embodiment, the cured compositions are floor coatings. In a preferred embodiment, these floor coatings have a longitudinal shrinkage of less than 3% in a layer thickness of more than 0.4 mm (as measured at 23° C./50% relative air humidity).

### EXAMPLES

### Measurement methods

### Epoxy Value (% EPO)

The content of oxirane groups (“epoxy groups”) in compounds was characterized by epoxy titration. The epoxy value (% EpO) obtained indicates how many grams oxirane oxygen are present in 100 grams of a sample.

Titration is Based on the Following Principle:

A solution containing excess tetraethyl ammonium bromide is added to the sample containing oxirane rings. The mixture is then titrated with a solution of perchloric acid in glacial acetic acid, an equimolar quantity of hydrogen bromide being released. The hydrogen bromide reacts with the oxirane rings in a ring opening reaction and forms the corresponding bromohydrin.

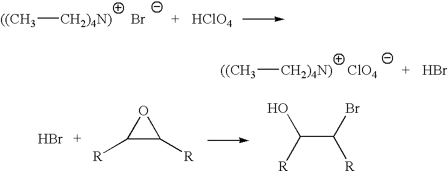

Crystal violet is used as the indicator. The determination presupposes the absence of water, bases and amines.

The following reagents were used: (1) 0.1 N perchloric acid (Merck) in glacial acetic acid; (2) tetraethyl ammonium bromide (Fluka) in the form of a solution of 100 g tetraethyl ammonium bromide in 400 ml glacial acetic acid; (3) crystal violet (Merck); the indicator solution was prepared by dissolving 0.2 g crystal violet in 100 ml glacial acetic acid.

Procedure: 0.2 to 0.5 g of the sample containing oxirane rings is placed in an Erlenmeyer flask. The sample is dissolved in 50 ml water-free acetone. 10 ml tetraethyl ammonium bromide solution (see above) and 3 drops crystal violet solution (see above) are then added. The mixture is titrated with a 0.1 N solution of perchloric acid in glacial acetic acid. The end point is reached when the color changes from blue to green. The actual titration is preceded by a blank test (no oxirane compound present) to rule out measurement errors.

Evaluation: The epoxy content % EpO is calculated as follows:
% EpO=[(a−b)×0.160]/E
where
a=milliliters 0.1 n HClO₄ solution required for titration,
b=milliliters 0.1 n HClO₄ solution needed in the blank test,
E=weight of sample in grams

### Epoxy Equivalent Weight (EEW)

The epoxy equivalent weight (EEW) can be calculated as follows from the epoxy value:
16×100/% EpO=EEW
The EEW is expressed in g/eq.

### ABBREVIATIONS

The abbreviations used in the following have the following meanings:
EEW: epoxy equivalent weight (as described above)
MW: average molecular weight

### Example 1

44 g poly(propyleneglycol)digycidyl ether (EEW 326, MW 652) were mixed at room temperature with 46.2 g bisphenol A diglycidyl ether (Chemres® E20, Cognis, EEW 194), 14.0 g bisphenol A and 0.1 g triphenylphosphine. The mixture obtained was heated to 160° C. and stirred at that temperature for ca. 3 hours until the epoxy value was 3.85%. The mixture was then cooled to 60° C. and 121.4 g diethylene triamine were added at that temperature. After the exothermic reaction had abated, the reaction mixture was re-heated for 2 hours to 160° C. The excess of diethylene triamine was distilled off in vacuo (up to 200° C. bottom temperature, pressures below 10 mbar) until no more free amine distilled over. The mixture was then cooled to 80° C. and 13.7 g propylene carbonate were added dropwise allowing for the exothermy. After another 4 hours' reaction at 160° C., 98.9 g water were added to the reaction mixture with thorough stirring.

247.5 g of a clear amber-colored liquid were obtained. Viscosity (Brookfield, 10 r.p.m., 40° C.): 1220 mPas.

### Example 2

44 g poly(propyleneglycol)digycidyl ether (EEW 326, MW 652) were mixed at room temperature with 46.2 g bisphenol A diglycidyl ether (Chemres® E20, Cognis, EEW 194), 14.0 g bisphenol A and 0.1 g triphenylphosphine. The mixture obtained was heated to 160° C. and stirred at that temperature for ca. 3 hours until the epoxy value was 3.85%. The mixture was then cooled to 60° C. and 121.4 g diethylene triamine were added at that temperature. After the exothermic reaction had abated, the reaction mixture was re-heated for 2 hours to 160° C. The excess of diethylene triamine was distilled off in vacuo (up to 200° C. bottom temperature, pressures below 10 mbar) until no more free amine distilled over. The mixture was then cooled to 80° C. and 11.6 g butyrolactone were added dropwise allowing for the exothermy. After another 2 hours' reaction at 90° C., 97.5 g water were added to the reaction mixture with thorough stirring.

243.7 g of a clear amber-colored liquid were obtained. Viscosity (Brookfield, 10 r.p.m., 40° C.): 1440 mPas.

### Example 3

44 g poly(propyleneglycol)digycidyl ether (EEW 326, MW 652) were mixed at room temperature with 46.2 g bisphenol A diglycidyl ether (Chemres® E20, Cognis, EEW 194), 14.0 g bisphenol A and 0.1 g triphenylphosphine. The mixture obtained was heated to 160° C. and stirred at that temperature for ca. 3 hours until the epoxy value was 3.85%. The mixture was then cooled to 60° C. and 121.4 g diethylene triamine were added at that temperature. After the exothermic reaction had abated, the reaction mixture was re-heated for 2 hours to 160° C. The excess of diethylene triamine was distilled off in vacuo (up to 200° C. bottom temperature, pressures below 10 mbar) until no more free amine distilled over. The mixture was then cooled to 90° C. and 89.5 g water were added with thorough stirring. The reaction mixture was then cooled to 50° C. and 1.9 g carbon dioxide were slowly introduced over a period of 1 h through a gas distribution tube with frit D2. The carbon dioxide taken up was determined by reweighing the entire apparatus.

226 g of a clear amber-colored liquid were obtained. Viscosity (Brookfield, 10 r.p.m., 40° C.): 2020 mPas.

### Comparison Example 1

44 g poly(propyleneglycol)digycidyl ether (EEW 326, MW 652) were mixed at room temperature with 46.2 g bisphenol A diglycidyl ether (Chemres® E20, Cognis, EEW 194), 14.0 g bisphenol A and 0.1 g triphenylphosphine. The mixture obtained was heated to 160° C. and stirred at that temperature for ca. 2 hours until the epoxy value was 3.95%. The mixture was then cooled to 60° C. and 91.1 g diethylene triamine were added at that temperature. After the exothermic reaction had abated, the reaction mixture was re-heated for 2 hours to 160° C. The excess of diethylene triamine was distilled off in vacuo (up to 200° C. bottom temperature, pressures below 10 mbar) until no more free amine distilled over. The mixture was then cooled to 90° C. and 89.5 g water were added with thorough stirring.

205.6 g of a clear amber-colored liquid were obtained. Viscosity (Brookfield, 10 r.p.m., 40° C.): 2140 mPas. Amine value: 134.

### Performance Tests

1. Clear Lacquer Properties

The hardeners of Examples 1 to 3 (hardener 60% in water) and Comparison Example 1 (hardener 60% in water) were made up into a clear lacquer by mixing the quantities shown in Table 1 of components Nos. 1 to 3 (the numbering of components Nos. 1 to 3 used appears in the first column of Table 1).

To this end, components No. 1 (epoxy resin) and No. 2 (hardener 60% in water) were thoroughly mixed with component No. 3 (water) in a glass beaker by stirring manually with a wooden spatula until a homogeneous emulsion had formed. The emulsion was then applied by coating knife (0.1 mm) to a pane of glass and left to cure at 20° C. After one day and seven days, the König pendulum hardness (DIN 53157) was determined with an Erichsen type 299 pendulum hardness tester.

In every case, the end of the pot life was reflected in a distinct increase in the viscosity of the emulsion to more than 3 times its initial viscosity. The pot life was ca. 60 minutes in every case. The lacquers obtained were clear and colorless. The tack-free time (time after which small glass balls or glass dust no longer adhere to the film) was ca. 1 hour in every case.

TABLE 1
Clear lacquer formulations

| No. | Properties/Test | E1 | E2 | E3 | C1 |
|---|---|---|---|---|---|
| | Lacquer | | | | |
| 1 | Chemres ® E30 (g) | 10 | 10 | 10 | 10 |
| 2 | Hardener 60% in water (g) | 16.9 | 17.1 | 12.3 | 11.7 |
| 3 | Water (g) | 11.0 | 15.0 | 11.0 | 9.7 |
| | Konig pendulum hardness after | 170 | 163 | 135 | 160 |
| | 1 day (0.1 mm film) | | | | |
| | Konig pendulum hardness after | 171 | 194 | 162 | 179 |
| | 1 day (0.1 mm film) | | | | |
| | Pot life [mins.] | 68 | 59 | 60 | 48 |

The column headings E1, E2, etc. in the first line of Table 1 have the following meanings:
E1 means that the clear lacquer formulation of column E1 contained the compound of Example 1 as component No. 2 (hardener).
E2 means that the clear lacquer formulation of column E2 contained the compound of Example 2 as component No. 2 (hardener).
E3 means that the clear lacquer formulation of column E3 contained the compound of Example 3 as component No. 2 (hardener).
C1 means that the clear lacquer formulation of column C1 contained the compound of Comparison Example I as component No. 2 (hardener).

The figures in columns E1, E2, etc. represent quantities in grams based on the components used.

The pot life of the curing mixture was determined by continuous viscosity measurement in a vessel kept at 20° C. using a Brookfield DV II, spindle RV 7, 20 r.p.m. The end of the pot life was reached at a viscosity of 20,000 mPas.

2. Floor Coating Composition for Determining Shrinkage

The hardeners of Examples 1 to 3 (hardener 60% in water) and Comparison Example 1 (hardener 60% in water) were mixed with the liquid components (components Nos. 6, 7, 8, 9 and 10) in the quantities shown in Table 2 and homogenized using a Pendraulik stirrer. The pigments (components Nos. 2, 3, 4, 5 and 11) were then successively stirred in homogeneously and dispersed for ca. 20 minutes with the Pendraulik stirrer.

Components Nos. 12 and 13 were then added to the mixture, followed by homogenization for ca. 4 minutes with the Pendraulik stirrer.

The numbering of components Nos. 1 to 13 used in the formulations appears in the first column of Table 2.

Foamaster® 223 was used as component No. 6. This product is a defoamer (Cognis).

Loxanol® DPN was used as component No. 7. This product is an open-time extender (Cognis).

Dowanol® TPM was used as component No. 8. This product is an auxiliary solvent (Cognis).

DSX® 1550 was used as component No. 9. This product is a thickener (Cognis).

Chemres® E95 was used as component No. 12. This product is an epoxy resin (Cognis).

In every case, a constant ratio of filler to binder of 4.2:1 was adjusted. To measure longitudinal shrinkage, the floor coating formulation obtained was poured into a prefabricated Teflon mold (length 150 mm, width 20 mm, depth 3 mm) and left to cure in a conditioning cabinet at 23° C./50% relative air humidity. The longitudinal shrinkage was determined by slide gage after 7, 14 and 28 days and was expressed as a percentage reduction, based on the original length of 150 mm.

TABLE 2
Shrinkage of floor coating compositions

| No. | Constituents/Example | E1 | E2 | E3 | C1 |
|---|---|---|---|---|---|
| 1 | Hardener 60% in water | 27.5 | 27.7 | 23.1 | 22.4 |
| 2 | Heucosin-Grau G 1978 | 9.5 | 9.5 | 9.5 | 9.5 |
| 3 | Heavy spar C14 | 16.3 | 16.3 | 16.3 | 16.3 |
| 4 | Minex S20 | 16.3 | 16.3 | 16.3 | 16.3 |
| 5 | Bentone EW | 2 | 2 | 2 | 2 |
| 6 | Foamaster ® 223 | 0.3 | 0.3 | 0.3 | 0.3 |
| 7 | Loxanol ® DPN | 0.6 | 0.6 | 0.6 | 0.6 |
| 8 | Dowanol ® TPM | 0.6 | 0.6 | 0.6 | 0.6 |
| 9 | DSX ® 1550 | 0.3 | 0.3 | 0.3 | 0.3 |
| 10 | Water | 10 | 10 | 10 | 10 |
| | Sum base-paint | 83.4 | 83.6 | 79.0 | 78.3 |
| 11 | Silica sand | 100 | 100 | 100 | 100 |
| | Sum | 183.4 | 183.6 | 179.0 | 178.3 |
| 12 | Chemres ® E95 (EEW | 17.3 | 17.2 | 20.0 | 20.4 |
| | 190) | | | | |
| 13 | Water | 8.2 | 8.2 | 10.1 | 10.2 |
| | Total sum | 209.0 | 209.0 | 209.0 | 208.9 |
| | % water in the formulation | 14 | 14 | 14 | 14 |
| | Sum fillers (Nos. 2, 3, 4, 5) | 142.2 | 142.2 | 142.2 | 142.2 |
| | Sum binders (sum of No. 1 | 33.8 | 33.8 | 33.8 | 33.8 |
| | without water and No. 12) | | | | |
| | Filler:binder ratio | 4.2 | 4.2 | 4.2 | 4.2 |
| | Shrinkage after 7 days (%) | 1.00 | 0.40 | 0.78 | 0.40 |
| | Shrinkage after 14 days (%) | — | 1.26 | 0.70 | 0.53 |
| | Shrinkage after 28 days (%) | 1.30 | 1.26 | 0.78 | 0.53 |

The column headings E1, E2, etc. in the first line of Table 2 have the same meanings as defined for Table 1:
E1 means that the clear lacquer formulation of column E1 contained the compound of Example 1 as component No. 1 (hardener). E2 means that the clear lacquer formulation of column E2 contained the compound of Example 2 as component No. 1 (hardener), etc.

The figures in columns E1, E2, etc. represent quantities in grams based on the components used and the balance lines “sum base-paint”, “sum” and “total sum”).

What is claimed is:

1. Hardeners for water-based epoxy resin systems providing a longer resin pot life, the hardeners being obtainable by
(i) reacting a mixture of
(A) at least one epoxidized polyalkylene oxide (A) selected from the group of epoxidized polyethylene oxides, epoxidized polypropylene oxides and polyethylene propylene oxides,
(B) at least one epoxidized aromatic hydroxy compound (B) selected from the group of bisphenol A epoxides and bisphenol F epoxides;
(C) at least one aromatic hydroxy compound (C) selected from the group of bisphenol A and bisphenol F; and
(D) optionally, at least one di- or tri-glycidyl ether compound (D) selected from the group of triglycidyl ethers of triols and a diglycidyl ether of diols,
to form a first intermediate product (Z1) having an epoxy value of less than 10%;
(ii) subsequently reacting the intermediate product (Z1) with a polyamine
(E) to form a second intermediate product (Z2); and
(iii) reacting the intermediate product (Z2) with at least one carbonyl compound (F) selected from the group of carbonyl-containing compounds corresponding to general formula (I): 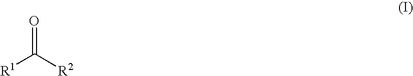
in which:
(a) the substituents R¹ and R² independently represent hydrogen, a saturated, linear or branched C₁₋₂₂ alkyl group or a C₆H₅, OH, OR³ group, where R³ is a saturated or unsaturated, linear or branched C₁₋₂₂ alkyl group, or
(b) R¹ and R² each represent a saturated C₁₋₂₂ alkyl group linked to one another and to the carbonyl carbon atom to form a ring, or
(c) R¹ and R² each represent a saturated C₁₋₂₂ alkyl group linked to one another and to the carbonyl carbon atom together with an —O— atom adjacent to the carbonyl carbon to form a lactone ring, or
(d) one of R¹ and R² represents a saturated C₁₋₂₂ alkyl group with an amino or OH group as substituent in the alpha position to the carbonyl carbon atom and the other represents OH or an OR³ group, where R³ is a saturated or unsaturated, linear or branched C₁₋₂₂ alkyl group, or
(e) R¹ and R² together represent oxygen,
with the proviso that at least 1% and at most 99% of the primary amino groups present in the intermediate product (Z2) are allowed to react off.

2. A hardener according to claim 1, wherein the at least one epoxidized polyalkylene oxide (A) is an epoxidized polypropylene oxide.

3. A hardener according to claim 1, wherein the at least one epoxidized aromatic hydroxy compound (B) is a bisphenol A epoxide.

4. A hardener according to claim 1, wherein the at least one aromatic hydroxy compound (C) is bisphenol A.

5. A hardener according to claim 1, wherein the at least one triglycidyl ether of triols or diglycidyl ether of diols (D) is present and is selected from the group consisting of ethylene glycol, diethylene glycol, triethylene glycol, 1,2-propylene glycol, 1,3-propylene glycol, 1,4-butylene glycol, pentane-1,5-diol, hexane-1,6-diol, cyclohexane diol, cyclohexane dimethanol, neopentyl glycol, hexane-1,2,6-triol, glycerol, trimethylol propane, and mixtures thereof.

6. A hardener according to claim 1, wherein the polyamine (E) is diethylenetriamine.

7. A hardener according to claim 1, wherein the carbonyl compound (F) is selected from the group consisting of carboxylic acids and anhydrides, carboxylic acid esters, lactones, acetone, formaldehyde, ketones, alpha-hydroxycarboxylic acids, alpha-aminocarboxylic acids, carbonates and carbon dioxide.

8. A hardener according to claim 1, wherein the carbonyl compound (F) is selected from the group consisting of gamma-butyrolactone, epsilon-caprolactone, ethylene carbonate, propylene carbonate, and carbon dioxide.

9. A hardener according to claim 1, wherein, in step (iii), at least 10% and at most 75% of the primary amino groups present in the intermediate product (Z2) are allowed to react off.

10. A hardener according to claim 1 providing a resin pot life of at least 60 minutes when combined with a polyepoxide.

11. A clear lacquer or coating composition comprising a hardener according to claim 1.

12. A process for producing a hardener for water-based epoxy resin systems providing a longer pot life, the process comprising
(i) reacting a mixture of
(A) at least one epoxidized polyalkylene oxide (A) selected from the group of epoxidized polyethylene oxides, epoxidized polypropylene oxides and polyethylene propylene oxides;
(B) at least one epoxidized aromatic hydroxy compound (B) selected from the group of bisphenol A epoxides and bisphenol F epoxides;
(C) at least one aromatic hydroxy compound (C) selected from the group of bisphenol A and bisphenol F; and
(D) optionally, at least one di- or tri-glycidyl ether compound (D) selected from the group of triglycidyl ethers of triols and diglycidyl ethers of diols,
to form a first intermediate product (Z1) having an epoxy value of less than 1 0%;
(ii) subsequently reacting this intermediate product (Z1) with a polyamine
(E) to form a second intermediate product (Z2); and
(iii) reacting the intermediate product (Z2) with at least one carbonyl compound (F) selected from the group of carbonyl-containing compounds corresponding to general formula (I): 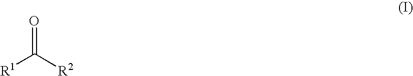
in which:
(a) the substituents R¹ and R² independently represent hydrogen, a saturated, linear or branched C₁₋₂₂ alkyl group or a C₆H₅, OH, OR³ group, where R³ is a saturated or unsaturated, linear or branched C₁₋₂₂ alkyl group, or
(b) R¹ and R² each represent a saturated C₁₋₂₂ alkyl group linked to one another and to the carbonyl carbon atom to form a ring, or
(c) R¹ and R² each represent a saturated C₁₋₂₂ alkyl group linked to one another and to the carbonyl carbon atom together with an —O— atom adjacent to the carbonyl carbon to form a lactone ring, or
(d) one of R¹ and R² represents a saturated C₁₋₂₂ alkyl group with an amino or OH group as substituent in the alpha position to the carbonyl carbon atom and the other represents OH or an OR³ group, where R³ is a saturated or unsaturated, linear or branched C₁₋₂₂ alkyl group, or
(e) R¹ and R² together represent oxygen,
with the proviso that at least 1% and at most 99% of the primary amino groups present in the intermediate product (Z2) are allowed to react off.

13. The process according to claim 12, wherein, in the production of the intermediate product (Z1), compounds (A) and (B) are used in a molar ratio of 0.1:1 to 5:1.

14. The process according to claim 12, wherein, in the production of the intermediate product (Z1), the molar ratio of the sum of compounds (A) and (B) to compound (C) is from 1.1:1 to 10:1.

15. The process according to claim 12, wherein at least one di- or tri-glycidyl ether compound (D) is used in the production of the intermediate product (Z1) and the molar ratio of the sum of compounds (A), (B) and (D) to compound (C) is from 1.1:1.0 to 10.0:1.0.

16. The process according to claim 12, wherein the production of the intermediate product (Z1) is carried out in the presence of triphenyl phosphine or ethyl triphenyl phosphonium iodide, which is present in an amount of about 0.01 to 1.0% by weight, based on the total quantity of compounds (A), (B) and (C).

17. The process according to claim 12, wherein the epoxy value of the intermediate product (Z1) is less than 5%.

18. The process according to claim 12, wherein the intermediate product (Z1) and the polyamine (E) are reacted in such quantities that the equivalent ratio of the reactive H atoms at the amino nitrogen atoms of (E) to the oxirane groups in the intermediate compound (Z1) is in the range from 4:1 to 100:1 and, at the same time, the ratio of oxirane groups to primary amines is at least 1:1.01.

19. The process according to claim 12, wherein, in step (iii), at least 10% and at most 75% of the primary amino groups present in the intermediate product (Z2) are allowed to react off.

20. The process according to claim 12, wherein one or more of the following selections are made: (1) the at least one epoxidized polyalkylene oxide (A) is an epoxidized polypropylene oxide; (2) the at least one epoxidized aromatic hydroxy compound (B) is a bisphenol A epoxide; or (3) the at least one aromatic hydroxy compound (C) is bisphenol A.

21. The process according to claim 12, wherein the at least one di- or tri-glycidyl ether (D) is selected from the group consisting of ethylene glycol, diethylene glycol, triethylene glycol, 1,2-propylene glycol, 1,3-propylene glycol, 1,4-butylene glycol, pentane-1,5-diol, hexane-1,6-diol, cyclohexane diol, cyclohexane dimethanol, neopentyl glycol, hexane-1,2,6-triol, glycerol, trimethylol propane, and mixtures thereof.

22. The process according to claim 12, wherein the polyamine (E) is diethylenetriamine.

23. The process according to claim 12, wherein the carbonyl compound (F) is selected from the group consisting of carboxylic acids and anhydrides, carboxylic acid esters, lactones, acetone, formaldehyde, ketones, alpha-hydroxycarboxylic acids, alpha-aminocarboxylic acids, carbonates and carbon dioxide.

24. The process according to claim 12, wherein the carbonyl compound (F) is selected from the group consisting of gamma-butyrolactone, epsilon-caprolactone, ethylene carbonate, propylene carbonate, and carbon dioxide.

25. The process according to claim 12, wherein, in the reaction of (Z2) with (F), at least 10% and at most 60% of the primary amino groups present in the intermediate product (Z2) are allowed to react off.

26. The process according to claim 12, wherein the intermediate (Z1) has an epoxy value of less than 5%.

27. A process for the production of a clear lacquer or a coating composition, comprising reacting, in an aqueous medium,
(1) a polyepoxide compound (G), containing an average of at least two terminal or lateral epoxy groups per molecule, with
(2) a hardener obtained by
(i) reacting a mixture of
(A) at least one epoxidized polyalkylene oxide (A) selected from the group of epoxidized polyethylene oxides, epoxidized polypropylene oxides and polyethylene propylene oxides;
(B) at least one epoxidized aromatic hydroxy compound (B) selected from the group of bisphenol A epoxides and bisphenol F epoxides;
(C) at least one aromatic hydroxy compound (C) selected from the group of bisphenol A and bisphenol F; and
(D) optionally, at least one di- or tri-glycidyl ether compound (D) selected from the group of triglycidyl ethers of triols and diglycidyl ethers of diols,
to form a first intermediate product (Z1) having an epoxy value of less than 10%,
(ii) subsequently reacting this intermediate product (Z1) with a polyamine
(E) to form a second intermediate product (Z2); and
(iii) reacting the intermediate product (Z2) with at least one carbonyl compound (F) selected from the group of carbonyl-containing compounds corresponding to general formula (I): 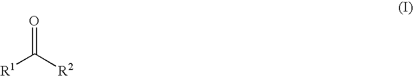
in which:
(a) the substituents R¹ and R² independently represent hydrogen, a saturated, linear or branched C₁₋₂₂ alkyl group or a C₆H₅, OH, OR³ group, where R³ is a saturated or unsaturated, linear or branched C₁₋₂₂ alkyl group, or
(b) R¹ and R² each represent a saturated C₁₋₂₂ alkyl group linked to one another and to the carbonyl carbon atom to form a ring, or
(c) R¹ and R² each represent a saturated C₁₋₂₂ alkyl group linked to one another and to the carbonyl carbon atom together with an —O— atom adjacent to the carbonyl carbon to form a lactone ring, or
(d) one of R¹ and R² represents a saturated C₁₋₂₂ alkyl group with an amino or OH group as substituent in the alpha position to the carbonyl carbon atom and the other represents OH or an OR³ group, where R³ is a saturated or unsaturated, linear or branched C₁₋₂₂ alkyl group, or
(e) R¹ and R² together represent oxygen,
with the proviso that at least 1% and at most 99% of the primary amino groups present in the intermediate product (Z2) are allowed to react off.

28. A process according to claim 27, wherein the carbonyl compound (F) is selected from the group consisting of carboxylic acids and anhydrides, carboxylic acid esters, lactones, acetone, formaldehyde, ketones, alpha-hydroxycarboxylic acids, alpha-aminocarboxylic acids, carbonates and carbon dioxide.

29. A process according to claim 24, wherein the carbonyl compound (F) is selected from the group consisting of gamma-butyrolactone, epsilon-caprolactone, ethylene carbonate, propylene carbonate, and carbon dioxide.

30. The process according to claim 24, wherein the intermediate (Z1) has an epoxy value of less than 5%.

31. A floor coating composition obtainable by the process according claim 27.

32. Cured floor coating compositions according to claim 27 having a longitudinal shrinkage of less than 3% in a layer thickness of more than 0.4 mm, as measured at 23° C./50% relative air humidity.
